(19) United States
(12) Patent Application Publication
(10) Pub. No.: US 2020/0202804 A1
(43) Pub. Date: Jun. 25, 2020

(54) DISPLAY

(71) Applicant: BODLE TECHNOLOGIES LTD., Oxford (GB)

(72) Inventors: SERGIO CASTILLO GARCIA, Oxford (GB); BEN BROUGHTON, Oxford (GB); PEIMAN HOSSEINI, Oxon (GB); CLEMENT TALAGRAND, Oxford (GB)

(21) Appl. No.: 16/621,051

(22) PCT Filed: Jun. 15, 2018
(86) PCT No.: PCT/GB2018/051670

§ 371 Date: Dec. 10, 2019

(30) Foreign Application Priority Data
Jun. 19, 2017 (GB) 1709734.6

(51) Int. Cl. G09G 3/36; G02F 1/01

(52) U.S. Cl. CPC G09G 3/3648; G09G 2300/0452; G02F 1/0147

(57) ABSTRACT

The disclosure relates to displays. In one arrangement a plurality of pixels are provided. Each pixel comprises a first optical element reversibly switchable between at least two optical states, and a second optical element reversibly switchable between at least two optical states. The first optical element overlaps spatially with the second optical element in an overlap region when viewed from a viewing side of the display, such that an overall optical effect for the overlap region is defined by a combination of the optical state of the first optical element and the optical state of the second optical element. Row signal lines and column signal lines allow individual addressing of each pixel by applying a combination of a row control signal and a column control signal to the pixel. A driving controller applies the row control signals and the column control signals to the pixels. For each pixel, the same row signal line and column signal line can be used to switch the first optical element and the second optical element independently of each other.

The present invention relates to a display in which individual pixels can be switched efficiently, particularly a display having pixels that operate using phase change material (PCM) to control colour and a separate optical shutter to control grey scale levels.

It is known to use PCMs in high resolution reflective displays and see-through displays. PCMs are materials that can be switched by electrical, optical or thermal means between a plurality of phases having different optoelectronic properties. Bi-stable PCMs are particularly attractive because after a phase transition has been completed it is not necessary to continuously apply power to maintain the new state. PCM optoelectronic devices can dynamically change their optical properties by initiating phase transitions in the PCMs using rapid pulses of thermal energy (supplied by any means, for example by electrical or optical means). Pixels can be switched across micron scale areas to achieve high resolution display properties.

PCM-based pixels can be switched efficiently between a particular colour (e.g. red, green or blue) and a highly reflectivity white state (e.g. having a reflectivity of at least 40%, desirably greater than 50% or 60%). It is challenging, however, to configure PCM-based pixels so that they can also provide the full range of black and grey scale levels needed for a full colour display.

It is an object of the invention to provide a display architecture that allows pixels to provide a wide range of optical effects while being addressable efficiently, particularly in the case where the pixels provide colour using PCMs.

According to an object of the invention, there is provided a display comprising: a plurality of pixels, each pixel comprising a first optical element reversibly switchable between at least two optical states, and a second optical element reversibly switchable between at least two optical states, the first optical element overlapping spatially with the second optical element in an overlap region when viewed from a viewing side of the display, such that an overall optical effect for the overlap region is defined by a combination of the optical state of the first optical element and the optical state of the second optical element; row signal lines and column signal lines configured to allow individual addressing of each pixel by applying a combination of a row control signal to the pixel, via a row signal line corresponding to the pixel, and a column control signal to the pixel, via a column signal line corresponding to the pixel; and a driving controller configured to apply the row control signals and the column control signals to the pixels via the row signal lines and the column signal lines, wherein: the driving controller and the pixels are configured such that, for each pixel, the same row signal line and column signal line can be used to switch the first optical element and the second optical element independently of each other.

Providing pixels that each have both first and second optical elements that overlap with each other allows the pixels to provide a wide range of optical effects. In an embodiment, each first optical element controls an overall intensity (grey scale level) of the pixel while each second optical element controls the colour of the pixel. In an embodiment, the first optical element comprises an optical shutter such as a suitably configured LCD element, electrowetting element, or MEMS element. In an embodiment, each second optical element comprises a PCM. Configuring the driving controller and the pixels such that each pixel can be addressed by the same row and column signal lines means that the hardware required to apply control signals to the pixels is not significantly more complex or bulky than the hardware that would be needed to provide control signals to pixels that each comprise only a single switchable element. The pixels can thus provide the wide range of optical effects while also being addressable efficiently. The arrangement is particularly desirable in the context of PCM-based pixels where it would be difficult simultaneously to achieve a full range of grey scales and colour control without having first and second optical elements that overlap each other in each pixel.

In an embodiment, each pixel is configured such that: when a first control signal profile is received by the pixel, the first control signal profile comprising a combination of a first row control signal and a first column control signal, the first optical element is switched from one optical state to a different optical state without any change in the optical state of the second optical element; and when a second control signal profile is received by the pixel, the second control signal profile being different from the first control signal profile and comprising a combination of a second row control signal and a second column control signal, the second optical element is switched from one optical state to a different optical state without any change in the optical state of the first optical element.

Thus, the first and second optical elements can be selectively switched simply by suitable selection of the profile of the control signal, without needing to provide two full sets of row and column signal lines for the first and second optical elements.

In an embodiment, the display further comprises an auxiliary switching system configured to allow the plurality of pixels to be switched as a group between a first operational state and a second operational state, the first operational state being such that, for each pixel, the first optical element can be switched between at least two optical states by application of a row control signal and a column control signal to the pixel and the second optical element cannot be switched between different optical states by application of a row control signal and a column control signal to the pixel; and the second operational state being such that, for each pixel, the second optical element can be switched between at least two optical states by application of a row control signal and a column control signal to the pixel and the first optical element cannot be switched between different optical states by application of a row control signal and a column control signal to the pixel.

Thus, the first and second optical elements can be selectively switched simply by controlling the timing of when control signals are sent to the pixels, without needing to provide two full sets of row and column signal lines for the first and second optical elements.

The invention will now be further described, by way of example, with reference to the accompanying drawings, in which:

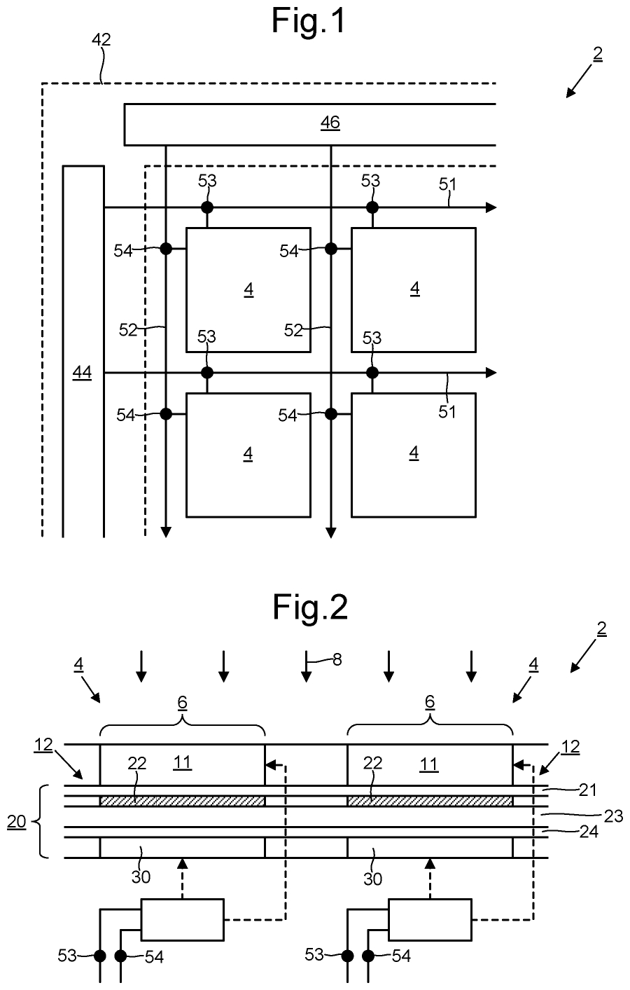

FIG. 1 schematically depicts driving electronics for a portion of a display according to an embodiment;

FIG. 2 is a schematic side sectional view depicting first and second optical elements of the display;

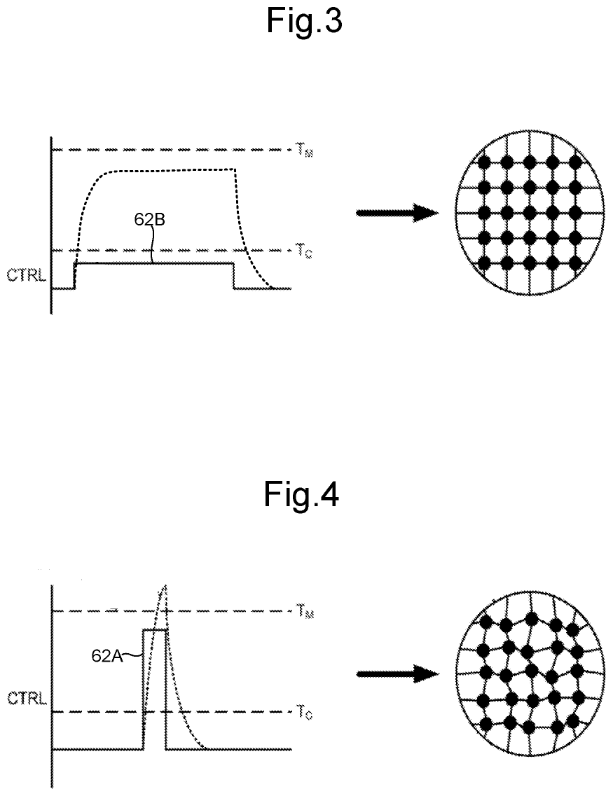

FIG. 3 depicts a heater control cycle (left) for switching an example PCM pixel into a crystalline state (depicted schematically on the right);

FIG. 4 depicts a heater control cycle (left) for switching an example PCM pixel into an amorphous state (depicted schematically on the right);

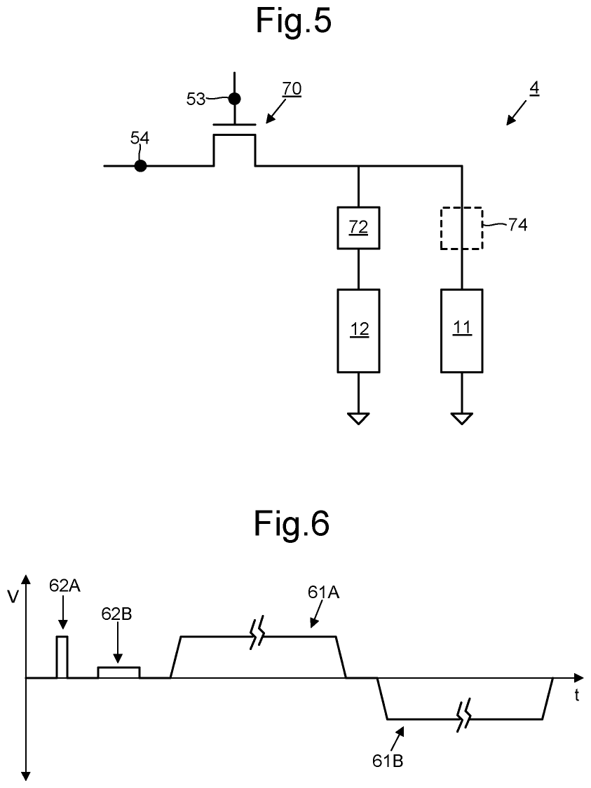

FIG. 5 depicts pixel driving electronics in which a high pass filter is provided to prevent a first control signal profile causing switching of a second optical element;

FIG. 6 depicts example control signals forming part of first and second control signal profiles;

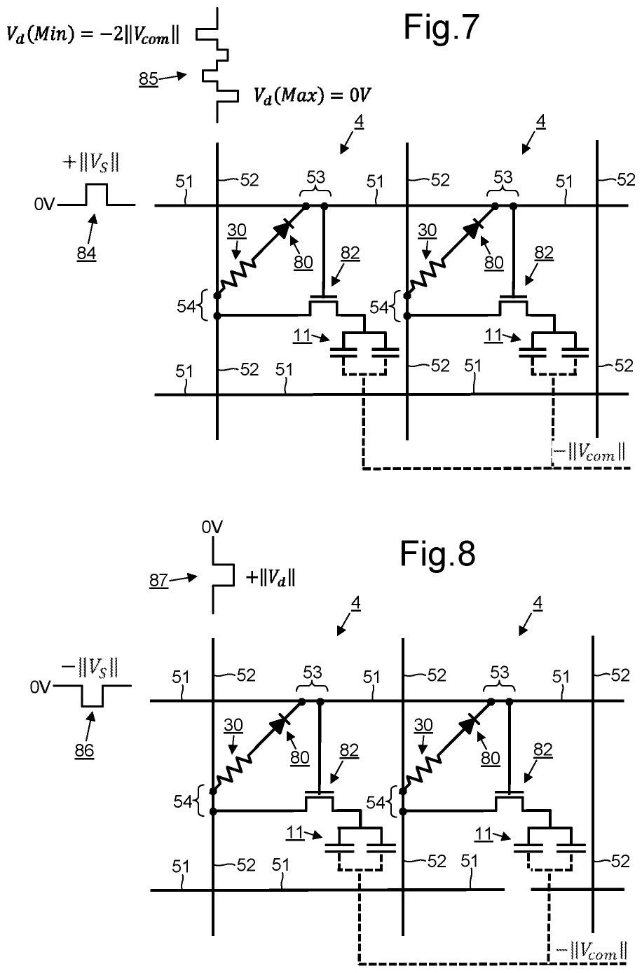

FIGS. 7 and 8 depict pixel driving electronics in which a diode is used in each pixel to prevent the optical state of a second optical element changing when a first control signal profile is received by the pixel (FIG. 7 shows the case where a first control signal profile is being received by the leftmost pixel and FIG. 8 shows the case where a second control signal profile is being received by the leftmost pixel);

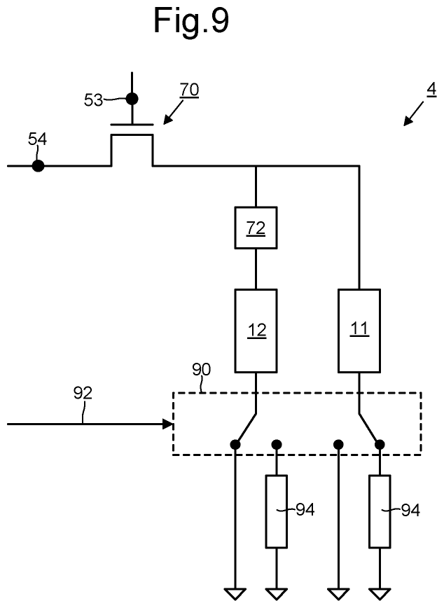

FIG. 9 depicts an auxiliary switching system;

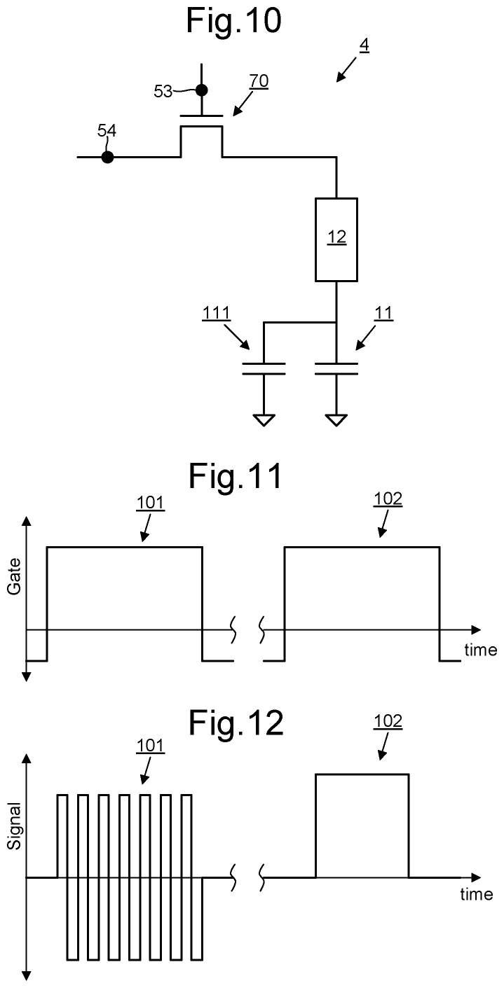

FIG. 10 depicts pixel driving electronics in which a second optical element is provided in series with a first optical element, with independent switching of the first and second optical elements being achieved via control signals having different frequency characteristics;

FIGS. 11 and 12 depict example control signals applied at points 53 and 54 of the circuit shown in FIG. 10; and

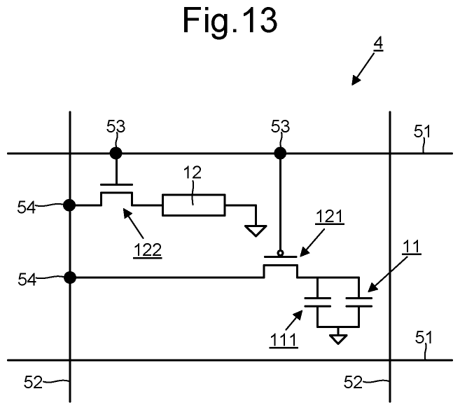

FIG. 13 depicts pixel driving electronics in which two transistors are configured to switch oppositely with respect to each other.

Throughout this specification, the terms “optical” and “light” are used, because they are the usual terms in the art relating to electromagnetic radiation, but it is understood that in the context of the present specification they are not limited to visible light. It is envisaged that the invention can also be used with wavelengths outside of the visible spectrum, such as with infrared and ultraviolet light.

FIGS. 1 and 2 depict driving electronics 2 for a portion of a display. The display comprises a plurality of pixels 4. Four example pixels 4 in a top left corner of the display are depicted in FIG. 1. Each pixel 4 comprises a first optical element 11 and a second optical element 12 (shown in FIG. 2). The first optical element 11 is reversibly switchable between at least two optical states. The second optical element 12 is reversibly switchable between at least two optical states. The first optical element 11 overlaps spatially with the second optical element 12 in an overlap region 6 when viewed from a viewing side of the display (e.g. from above, along arrows 8, in FIG. 2). The overall optical effect for the overlap region 6 is defined by a combination of the optical state of the first optical element 11 and the optical state of the second optical element 12.

In an embodiment, the first optical element 11 can be tuned through a continuous range of optical states. In an embodiment, the first optical element 11 controls an overall intensity of the pixel 4. In an embodiment, the first optical element 11 is switchable between a set of optical states comprising at least one optical state having a transmittance of less than 10% and at least one optical state having a transmittance of greater than 90%. The first optical element 11 can thus be used to control a grey scale level of the pixel 4 in the overlap region 6.

In an embodiment the first optical element 11 comprises a liquid crystal display (LCD) element, comprising for example one or more of the following: an LCD with polarizer, a polarizer-free LCD, a dye-doped LCD. Alternatively or additionally, the first optical element 11 may comprise an electrowetting optical element or a MEMS element. Any other element providing the desired optical properties (e.g. grey scale control) may be used.

In an embodiment, the second optical element 12 controls the colour of the pixel 4 in the overlap region 6. The second optical element 12 is switchable between a set of optical states comprising at least two optical states having different colours. In an embodiment, the different colours include red and white, blue and white, or green and white. In an embodiment, the second optical element 12 comprises a PCM that is thermally switchable between a plurality of stable states having different refractive indices relative to each other.

In an embodiment, as depicted in FIG. 2, the second optical element 12 comprises a stack 20 of layers. The stack 20 comprises a PCM 22. The PCM 22 may be provided as a continuous layer spanning across multiple pixels 4 (as in the example of FIG. 2) or a separate PCM layer may be provided for each pixel 4. Each second optical element 12 comprises a portion of PCM 22 that is thermally switchable at least predominantly independently of the portion of PCM 22 of any of the other second optical elements 12 (although there may be some cross-talk between pixels where heating intended to switch the PCM 22 of the second optical element 12 of one pixel 4 also causes a degree of heating in the PCM 22 of the second optical element 12 of a neighbouring pixel 4).

The PCM 22 of each second optical element 12 is switchable between a plurality of stable states having different refractive indices relative to each other. In an embodiment, the switching is reversible. Each stable state has a different refractive index (optionally including a different imaginary component of the refractive index, and thereby a different absorbance) relative to each of the other stable states. In an embodiment all layers in each stack 20 are solid-state and configured so that their thicknesses as well as refractive index and absorption properties combine so that the different states of the PCM 22 result in different, visibly and/or measurably distinct, reflection spectra. Optical devices of this type are described in Nature 511, 206-211 (10 Jul. 2014), WO2015/097468A1, WO2015/097469A1, EP16000280.4 and PCT/GB2016/053196.

In an embodiment the PCM 22 comprises, consists essentially of, or consists of, one or more of the following: an oxide of vanadium (which may also be referred to as VOx); an oxide of niobium (which may also be referred to as NbOx); an alloy or compound comprising Ge, Sb, and Te; an alloy or compound comprising Ge and Te; an alloy or compound comprising Ge and Sb; an alloy or compound comprising Ga and Sb; an alloy or compound comprising Ag, In, Sb, and Te; an alloy or compound comprising In and Sb; an alloy or compound comprising In, Sb, and Te; an alloy or compound comprising In and Se; an alloy or compound comprising Sb and Te; an alloy or compound comprising Te, Ge, Sb, and S; an alloy or compound comprising Ag, Sb, and Se; an alloy or compound comprising Sb and Se; an alloy or compound comprising Ge, Sb, Mn, and Sn; an alloy or compound comprising Ag, Sb, and Te; an alloy or compound comprising Au, Sb, and Te; and an alloy or compound comprising Al and Sb (including the following compounds/alloys in any stable stoichiometry: GeSbTe, VOx, NbOx, GeTe, GeSb, GaSb, AgInSbTe, InSb, InSbTe, InSe, SbTe, TeGeSbS, AgSbSe, SbSe, GeSbMnSn, AgSbTe, AuSbTe, and AlSb). Preferably, the PCM 22 comprises one of Ge₂Sb₂Te₅ and Ag₃In₄Sb₇₆Te₁₇. It is also understood that various stoichiometric forms of these materials are possible: for example GeₓSb_{y}Te_{z}; and another suitable material is Ag₃In₄Sb₇₆Te₁₇ (also known as AIST). Furthermore, any of the above materials can comprise one or more dopants, such as C or N. Other materials may be used.

PCMs are known that undergo a drastic change in both the real and imaginary refractive index when switched between amorphous and crystalline phases. The switching can be achieved for example by heating induced by suitable electric pulses or by a light pulse from a laser light source, or, as in embodiments described below, by thermal conduction of heat generated by a switching element in thermal contact with the PCM 22. There is a substantial change in the refractive index when the material is switched between amorphous and crystalline phases. The material is stable in either state. Switching can be performed an effectively limitless number of times. However, it is not essential that the switching is reversible.

Although some embodiments described herein mention that the PCM 22 is switchable between two states such as crystalline and amorphous phases, the transformation could be between any two solid phases, including, but not limited to: crystalline to another crystalline or quasi-crystalline phase or vice-versa; amorphous to crystalline or quasi-crystalline/semi-ordered or vice versa, and all forms in between. Embodiments are also not limited to just two states.

In an embodiment, the PCM 22 comprises Ge₂Sb₂Te₅ (GST) in a layer less than 200 nm thick. In another embodiment, the PCM 22 comprises GeTe (not necessarily in an alloy of equal proportions) in a layer less than 100 nm thick.

A plurality of switching elements 30 are provided for selectively actuating each of the second optical elements 12 as desired. Each switching element 30 selectively heats the PCM 22 of the selected second optical element 12 to perform the thermal switching. Examples of thermal heating profiles (temperature against time) suitable for example switches (amorphous to crystalline and crystalline to amorphous) are shown in FIGS. 3 and 4. Here, a switching element 30 comprising a resistive heating element is driven by a control signal CTRL. The control signal CTRL in this example comprises a current pulse of one of two predefined types, each different type of pulse being suitable for generating a variation of temperature with time (a heating profile) that is suitable for a different type of switching. The control signals CTRL are examples of control signals 62A and 62B forming parts of second control signal profiles and will be discussed further below.

In FIG. 3 the control signal CTRL (solid line) comprises a pulse of relatively low amplitude and long duration. The pulse provides a first heating profile (dotted line) effective for switching the PCM 22 to a crystalline state (shown on the right). The first heating profile is such that the PCM 22 is heated to a temperature higher than the crystallization temperature T_{C} of the PCM 22, but less than the melting temperature T_{M} of the PCM 22. The temperature is maintained above the crystallization temperature T_{C} for a time sufficient to crystallize the PCM 22.

In FIG. 4 the control signal CTRL (solid line) comprises a pulse of higher amplitude but shorter duration. The pulse provides a second heating profile (dotted line) effective for switching the PCM 22 to an amorphous state (shown on the right). The second heating profile is such that the PCM 22 is heated to a temperature that is higher than the melting temperature T_{M}, causing melting of the PCM 22, but is cooled sufficiently quickly that re-crystallization does not occur excessively and the PCM 22 freezes into an amorphous state. It is important for this process that the resistive heating element is in good thermal contact with the PCM 22 and that heat can escape sufficiently quickly from the PCM 22 to achieve the rapid cooling necessary to prevent re-crystallization.

As demonstrated in the example of FIGS. 3 and 4, after the heating of the PCM 22 has finished the PCM 22 remains in the stable state selected (e.g. amorphous or crystalline) until further heating is applied. Thus, when based on PCM the second optical element 12 is naturally held in a given optical state without application of any signal, and can thus operate with significantly less power than other display technologies. Switching can be performed an effectively limitless number of times. The switching speed is also very rapid, typically less than 300 ns, and certainly several orders faster than the human eye can perceive.

In the particular example of FIG. 2, the stack 20 of each second optical element 12 comprises a reflective layer 24. In the example of FIG. 2 the reflective layer 24 spans across multiple pixels 4. The reflective layer 24 may be made highly reflective or only partially reflective. The reflective layer 24 may be omitted. In an embodiment, the reflective layer 24 comprises reflective material such as a metal. Metals are known to provide good reflectivity (when sufficiently thick) and also have high thermal and electrical conductivities. The reflective layer 24 may have a reflectance of 50% or more, optionally 90% or more, optionally 99% or more, with respect to visible light, infrared light, and/or ultraviolet light. The reflective layer 24 may comprise a thin metal film, composed for example of Au, Ag, Al, or Pt. If this layer is to be partially reflective then a thickness in the range of 5 to 15 nm might be selected, otherwise the layer is made thicker, such as 100 nm, to be substantially totally reflective.

In the embodiment of FIG. 2 the stack 20 of each second optical element 12 further comprises a spacer layer 23. The spacer layer 23 is between the PCM 22 and the reflective layer 24.

In the embodiment of FIG. 2 the stack 20 of each second optical element 12 further comprises a capping layer 21. The PCM 22 is between the capping layer 21 and the reflective layer 24. In this particular embodiment, the upper surface of the capping layer 21 faces towards a viewing side of the apparatus, and the reflective layer 24 acts as a back-reflector when required as a mirror. Light enters and leaves through the viewing surface (from above in FIG. 2). However, because of interference effects which are dependent on the refractive index of the PCM 22 and the thickness of the spacer layer 23, the reflectivity varies significantly as a function of wavelength. The spacer layer 23 and the capping layer 21 are both optically transmissive, and are ideally as transparent as possible.

Each of the capping layer 21 and spacer layer 23 may consist of a single layer or comprise multiple layers having different refractive indices relative to each other (i.e. where the capping layer 21 or spacer layer 23 consists of multiple layers at least two of those layers have different refractive indices relative to each other). The thickness and refractive index of the material or materials forming the capping layer 21 and/or spacer layer 23 are chosen to create a desired spectral response (via interference and/or absorption). Materials which may be used to form the capping layer 21 and/or spacer layer 23 may include (but are not limited to) ZnO, TiO₂, SiO₂, Si₃N₄, TaO and ITO.

In an embodiment, the switching element 30 comprises a resistive heating element. The switching element 30 may for example comprise a metal or metal alloy material that exhibits suitable resistivity and high thermal conductivity. For example, the switching element 30 can be formed from titanium nitride (TiN), tantalum nitride (TaN), nickel chromium silicon (NiCrSi), nickel chromium (NiCr), tungsten (W), titanium-tungsten (TiW), platinum (Pt), tantalum (Ta), molybdenum (Mo), niobium (Nb), or iridium (Ir), or any of a variety of or a combination of similar metal or metal alloys that have the above properties and have a melting temperature that is higher than the melting temperature of the PCM 22. In other embodiments the switching element 30 may comprise a non-metallic or metal oxide (e.g. ITO) material.

In an embodiment, the stack 20 further comprises a barrier layer (not shown) between the switching element 30 and the rest of the layers of the stack 20 (above the switching element 30). In an embodiment, the barrier layer is an electrical insulator that is thermally conductive such that the barrier layer electrically insulates the switching element 30 from the PCM 22, but allows heat from the switching element 30 to pass through the barrier layer to the PCM 22 to change the state of the PCM 22, for example to a crystallized state in response to a first heating profile and to an amorphous state in response to a second heating profile. In example embodiments the barrier layer comprises one or more of the following: SiN, AlN, SiO₂, silicon carbide (SiC), and diamond (C).

Any or all of the layers in each stack 20 may be formed by sputtering, which can be performed at a relatively low temperature of 100 degrees C. The layers can also be patterned using conventional techniques known from lithography, or other techniques e.g. from printing. Additional layers may also be provided for the device as necessary.

In a particular embodiment, the PCM 22 comprises GST, is less than 100 nm thick, and preferably less than 10 nm thick, such as 6 or 7 nm thick. The spacer layer 23 is grown to have a thickness typically in the range from 10 nm to 250 nm, depending on the colour and optical properties required. The capping layer 21 is, for example, 20 nm thick.

As shown schematically in FIG. 1, driving electronics 2 for driving the pixels 4 comprise a driving controller 42. The driving controller 42 comprises a row driver 44 and a column driver 46. The row driver 44 and column driver 46 provide driving signals to the pixels 4 via row signal lines 51 and column signal lines 52. The row signal lines 51 connect to each pixel 4 via a row connection 53 corresponding to the pixel 4. The column signal lines 52 connect to each pixel 4 via a column connection 54 corresponding to the pixel 4. The row and column signal lines 51,52 allow individual addressing of each pixel 4 by applying a combination of a row control signal and a column control signal to the pixel 4 via the row connection 53 and the column connection 54 corresponding to the pixel 4.

The driving controller 42 and pixels 4 are configured such that, for each pixel 4, the same row and column connections 53,54 (and the same row and column signal lines 51,52) can be used to switch the first optical element 11 and the second optical element 12 independently of each other. In other words signals for switching the first optical elements 11 of the pixels 4 can be sent along the same electrical paths as signals for switching the second optical elements 12 of the pixels 4. It is not necessary to provide separate row and column signal lines and/or connections in order to provide control signals to the pixels 4 that are effective for controlling switching of the first and second optical elements independently of each other.

In an embodiment, each pixel 4 is configured such that the following behaviour is achieved. When a first control signal profile is received by the pixel 4, the first control signal profile comprising a combination of a first row control signal and a first column control signal, the first optical element 11 is switched from one optical state to a different optical state without any change in the optical state of the second optical element 12. Additionally, when a second control signal profile is received by the pixel 4, the second control signal profile being different from the first control signal profile and comprising a combination of a second row control signal and a second column control signal, the second optical element 12 is switched from one optical state to a different optical state without any change in the optical state of the first optical element 11. In an embodiment, this is achieved by arranging for the first and second optical elements 11,12 to be respectively responsive to control signals having different frequency characteristics. This may be the case when the control signals are applied directly to the first and/or second optical elements 11, 12 or one or more filters may be provided to filter signals arriving at one or both of the first and second optical elements 11,12.

In an embodiment, each pixel 4 comprises a first filter 72 that prevents the optical state of the second optical element 12 changing when the first control signal profile is received by the pixel 4. An example of such an arrangement is depicted schematically in FIG. 5. Here, a transistor 70 is controlled by a pulse from row connection 53 to open or close a current path from the column connection 54 to the first and second optical elements 11 and 12. When the current path is open the signal from column connection 54 is applied directly to the first optical element 11 and to the second optical element 12 via the first filter 72. In an embodiment the first filter 72 comprises a high pass filter such as a capacitor. In the example of FIG. 5, the first optical element 11 comprises an LCD element which is switchable between different states by applying a relatively low frequency signal. Examples of control signals 61A and 61B suitable for switching an optical state of an LCD element (e.g. when applied via column connection 54) are depicted schematically in FIG. 6. The switching of the optical state of the LCD element may be achieved by applying a control signal of relatively uniform amplitude for a relative long period (e.g. a few ms). In the example of FIG. 5, the second optical element 12 comprises a PCM and is switchable using control signals 62A and 62B of relatively short duration (e.g. tens of μs or less). The control signals 62A and 62B may for example take the forms depicted in FIGS. 3 and 4 (see labels 62A and 62B in FIGS. 3 and 4).

When the relatively long (low frequency) control signals 61A and 61B are applied, the high pass filter 72 effectively prevents the control signals having any effect on the second optical element 12 (e.g. no significant current will be driven through the resistive heating element of the second optical element 12 and no heating will be applied to the PCM 22). The control signals 61A and 61B will, however, be able to cause switching of the first optical element 11, where no filter is present in the signal path.

When the relatively short (high frequency) control signals 62A and 62B are applied, the high pass filter 72 no longer prevents them being applied to the second optical element 12 and switching of the second optical element 12 can be achieved as desired (e.g. as described above with reference to FIGS. 3 and 4). The control signals 62A and 62B will also be applied to the first optical element 11 but will not have any effect because the first optical element 11 is not responsive to such short pulses. The short pulses are not long enough to have any significant effect on the optical state of the LCD element.

In an embodiment, the pixel 4 further comprises a second filter 74 that prevents the optical state of the first optical element 11 changing when the second control signal profile is received by the pixel 4. The second filter 74 is not provided in the particular example of FIG. 5 but could be positioned where indicated by the broken line box.

FIGS. 7 and 8 depict example driving electronics for an alternative class of embodiments in which each pixel 4 comprises a diode 80 (or a TFT with connected drain and gate configured to operate as a diode, thereby providing a fully TFT process) that prevents the optical state of the second optical element 12 changing when the first control signal profile is received by the pixel 4. In this example the first optical element 11 comprises an LCD element and the second optical element 12 comprises a PCM. The diode 80 is connected in a series circuit comprising the diode 80 and a resistive element 30 (i.e. such that the diode 80 and resistive element 30 are electrically in series with each other) configured to drive switching of the PCM of the second optical element 12 by Joule heating in the resistive element 30. The series circuit is connected between the row signal line 51 and the column signal line 52 corresponding to the pixel. The series circuit is such that a first control signal profile can be applied that is such as to cause switching of the optical state of the first optical element 11 while applying a reverse bias across the diode 80. An example first control signal profile is depicted in the top left of the FIG. 7. The example first control signal profile is being applied to the leftmost of the two pixels 4 depicted in FIG. 7. The first control signal profile comprises a first control signal row component 84, which is applied to the pixel 4 via the row signal line 51 leading to the pixel 4, and a first control signal column component 85, which is applied to the pixel 4 via the column signal line 52 leading to the pixel 4. In this example the first control signal row component 84 comprises a voltage pulse of positive amplitude and the first control signal column component 85 oscillates about a negative voltage of −∥V_{com}∥ but does not exceed 0V, thereby providing the reverse bias across the diode 80. The reverse bias across the diode 80 prevents any significant current flowing through the resistive element 30 and therefore prevents switching of the second optical element 12.

In the embodiment of FIGS. 7 and 8, each pixel 4 further comprises a transistor 82 that controls whether current can be driven through the first optical element 11. When the first control signal profile shown in FIG. 7 is applied, transistor 82 closes the connection between the column signal line 52 and the first optical element 11, thereby allowing the first control signal column component 85 (Vd in the negative range) to drive switching of the first optical element 11 as desired. Optionally, the diode 80 in each pixel 4 may itself comprise a transistor, or thin-film transistor, similar to that of 82, with the gate connection shorted to the source or drain, so as to form a diode from the transistor structure. Being able to fabricate the diode and transistor in each pixel from the same structure, using the same deposition steps, may simplify overall fabrication of the device by e.g. reducing the number of mask steps required in photolithography.

In an embodiment, the series circuit is such that a second control signal profile can be applied that is such as to cause switching of the optical state of the second optical element 12 by applying a forward bias across the diode 80 and Joule heating in the resistive element 30. An example second control signal profile is depicted in the top left of FIG. 8. The example second control signal profile is being applied to the leftmost of the two pixels 4 depicted in FIG. 8. The second control signal profile comprises a second control signal row component 86, which is applied to the pixel 4 via the row signal line 51 leading to the pixel 4, and a second control signal column component 87, which is applied to the pixel 4 via the column signal line 52 leading to the pixel 4. In this example the second control signal row component 86 comprises a voltage pulse of negative amplitude and the second control signal column component 87 comprises a voltage pulse of positive amplitude, thereby providing the forward bias across the diode 80. The second control signal profile can thus drive current through the resistive element 30 and drive switching of the second optical element 12 as desired. At the same time, the negative voltage applied along the row signal line causes the transistor 82 to open the connection between the column signal line 52 and the first optical element 11, thereby preventing flow of current from the column signal line 52 to the first optical element 11. The transistor 82 thus prevents the optical state of the first optical element 11 changing when the second control signal profile is received by the pixel 4.

FIG. 9 depicts an example of an alternative approach in which an auxiliary switching system 90 is used to allow the plurality of pixels 4 to be switched as a group between a first operational state and a second operational state. The first operational state is such that, for each pixel 4, the first optical element 11 can be switched between at least two optical states by application of a row control signal and a column control signal to the pixel 4 and the second optical element 12 cannot be switched between different optical states by application of a row control signal and a column control signal to the pixel 4. The second operational state is such that, for each pixel 4, the second optical element 12 can be switched between at least two optical states by application of a row control signal and a column control signal to the pixel 4 and the first optical element 11 cannot be switched between different optical states by application of a row control signal and a column control signal to the pixel 4.

In the example of FIG. 9 it can be seen that if the switches within auxiliary switching system 90 are configured to connect the second optical element 12 directly to ground and the first optical element 11 to ground via a large resistor 94, the second operational state can be achieved.

In an embodiment, the driving controller 42 controls the auxiliary switching system 90 via a control signal 92. The driving controller 42 controls the auxiliary switching system 90 such that the pixels 4 are switched alternately between the first operational state and the second operational state using the auxiliary switching system 90. The overall optical effect in the overlap region of each pixel 4 can therefore be controlled by applying appropriate signals to the first optical element 11 and the second optical element 12 of each pixel 4 serially, one after the other. The driving controller 42 can control switching of the first optical elements 11 of the pixels 4 by applying the row control signals and the column control signals to the pixels 4 while the pixels 4 are in the first operational state. The driving controller 42 can control switching of the second optical elements 12 by applying row control signals and column control signals to the pixels 4 while the pixels 4 are in the second operational state.

In a further embodiment, the first optical element 11 and the second optical element 12 are connected electrically in series, rather than in parallel as in the embodiments of FIGS. 5 and 9, or in separately selectable electrical paths as in the embodiments of FIGS. 7 and 8. In this case, the activation of each element independently of each other may be done via choice of frequency of the drive signal (to exploit the first optical element 11 and the second optical element 12 being respectively responsive to control signals having different frequency characteristics). FIG. 10 illustrates one such embodiment in which the first optical element 11 is represented electrically as a capacitor, as is applicable where the first optical element 11 comprises a liquid crystal or electrowetting optical element (where transmission is dependent on the voltage set and maintained on the capacitor representing such elements), and the second optical element 12 is represented electrically as a resistor, as in the embodiments of FIGS. 7 and 8.

FIGS. 11 and 12 respectively show control signals applied to the gate of the transistor 70 at point 53 and to the signal line at point 54 in the pixel 4 depicted in FIG. 10. When the pixel 4 is activated by a positive voltage pulse applied to the gate at 53 (period 101 in FIG. 11), the pixel 4 is connected to the signal line 54. In this state, energy may be dissipated in the second optical element 12 by the application of a high frequency ac signal to the signal line 54 (period 101 in FIG. 12), thereby causing the second optical element 12 to switch states. Such a signal will cause the first optical element 11 to appear as low impedance, as long as the frequency is higher than the RC constant of the effective circuit, and such a signal will also not affect the optical state of the first optical element 11 as long as the total duration of the high frequency ac signal is shorter than the effective optical response time of the first optical element 11. Liquid crystal and electrowetting devices respond to the rms voltage applied to them in the same way as a capacitor, and typically have an optical response time of several milliseconds. A high frequency ac signal of a few hundred microseconds is typically enough to switch a phase-change material device of the type envisaged for the second optical element 12, so such a switching signal would not cause an optical response in a first optical element 11 comprising an LC or electrowetting device.

Conversely, when the pixel 4 is subject to a dc signal on the signal line 54 (period 102 in FIGS. 11 and 12), the first optical element 11 (behaving like a capacitor) will charge to the voltage of the applied dc signal, which will in turn control the optical response of the first optical element 11. Although some energy will be dissipated in the second optical element 12 (behaving like a resistor) during this capacitor charging period, because of the high impedance produced by the charging capacitor to this dc signal, the current through the two elements (the first optical element 11 and the second optical element 12) will be very limited, causing the dissipation of energy in the second optical element 12 to remain beneath the threshold at which any optical response occurs.

The arrangement of FIG. 10 thus allows for independent actuation of each of the two optical elements in each pixel 4 with a simplified effective circuit retaining only a single transistor, gate line and signal line per pixel 4. Furthermore, the effective capacitance, and therefore RC constant of the pixel 4 may be controlled by the addition of a second storage capacitor 111 in parallel with the first optical element 11 (represented as a capacitor). The arrangement of FIG. 10 is an example of an embodiment in which each pixel 4 is such that the first optical element 11 and the second optical element 12 are respectively responsive to control signals having different frequency characteristics and these different frequency characteristics are exploited to provide the independent switching of the first optical element 11 and the second optical element 12 via the same row and column signal lines.

FIG. 13 depicts an example of an alternative embodiment in which each pixel 4 comprises two transistors configured to switch oppositely with respect to each other when they receive the same control signal. In embodiments of this type, each pixel 4 comprises a first transistor 121 and a second transistor 122. A gate of the first transistor 121 and a gate of the second transistor 122 are both connected to the row signal line 51 at points 53. The first transistor 121 and the second transistor 122 are configured so that a first row control signal (e.g. a predetermined positive voltage or a predetermined negative voltage) applied simultaneously to the gate of the first transistor 121 and the gate of the second transistor 122 is effective to open the first transistor 121 and close the second transistor 122. This may be achieved for example by arranging for the first transistor 121 to be n-type and the second transistor 122 to be p-type or for the first transistor 121 to be p-type and the second transistor 122 to be n-type. When the first transistor 121 is open, electric current can flow through the first transistor, driven by a column control signal applied at point 54 on the column signal line 52, thereby allowing switching of the first optical element 11 (which, as discussed above with reference to FIG. 10, may behave like a capacitor, with an optional second storage capacitor 111 being provided in parallel). When the second transistor 122 is closed, no significant current can flow through the second transistor 122 and switching of the second optical element by the column control signal applied at point 54 is prevented.

The first transistor 121 and the second transistor 122 are also configured so that, conversely, a second row control signal (e.g. a predetermined negative voltage or a predetermined positive voltage of opposite sign to the first row control signal) applied simultaneously to the gate of the first transistor 121 and the gate of the second transistor 122 is effective to open the second transistor 122 and close the first transistor 122. This may be achieved for example by arranging for the first transistor 121 to be n-type and the second transistor 122 to be p-type or for the first transistor 121 to be p-type and the second transistor 122 to be n-type. When the second transistor 122 is open, electric current can flow through the second transistor 122, driven by a column control signal applied at point 54 on the column signal line 52, thereby allowing switching of the second optical element 12 (which, as discussed above with reference to FIG. 10, may behave like a resistor). When the first transistor 121 is closed, no significant current can flow through the first transistor 121 and switching of the first optical element 11 by the column control signal applied at point 54 is prevented.

In a variation of the embodiment of FIG. 13, the gates of the first transistor 121 and second transistor 122 may be connected to the column signal line 52 instead of the row signal line 51.

1. A display comprising:
a plurality of pixels, each pixel comprising a first optical element reversibly switchable between at least two optical states, and a second optical element reversibly switchable between at least two optical states, the first optical element overlapping spatially with the second optical element in an overlap region when viewed from a viewing side of the display, such that an overall optical effect for the overlap region is defined by a combination of the optical state of the first optical element and the optical state of the second optical element;
row signal lines and column signal lines configured to allow individual addressing of each pixel by applying a combination of a row control signal to the pixel, via a row signal line corresponding to the pixel, and a column control signal to the pixel, via a column signal line corresponding to the pixel; and
a driving controller configured to apply the row control signals and the column control signals to the pixels via the row signal lines and the column signal lines, wherein:
the driving controller and the pixels are configured such that, for each pixel, the same row signal line and column signal line can be used to switch the first optical element and the second optical element independently of each other.

2. The display of claim 1, wherein each pixel is configured such that:
when a first control signal profile is received by the pixel, the first control signal profile comprising a combination of a first row control signal and a first column control signal, the first optical element is switched from one optical state to a different optical state without any change in the optical state of the second optical element; and
when a second control signal profile is received by the pixel, the second control signal profile being different from the first control signal profile and comprising a combination of a second row control signal and a second column control signal, the second optical element is switched from one optical state to a different optical state without any change in the optical state of the first optical element.

3. The display of claim 2, wherein the pixel comprises a first filter configured to prevent the optical state of the second optical element changing when the first control signal profile is received by the pixel.

4. The display of claim 3, wherein the first filter comprises a high pass filter.

5. The display of claim 2, wherein the pixel comprises a second filter configured to prevent the optical state of the first optical element changing when the second control signal profile is received by the pixel.

6. The display of claim 2, wherein the pixel comprises a diode, or a TFT with connected drain and gate configured to operate as a diode, configured to prevent the optical state of the second optical element changing when the first control signal profile is received by the pixel.

7. The display of claim 6, wherein:
the diode or TFT with connected drain and gate is connected in a series circuit comprising the diode or TFT with connected drain and gate and a resistive element configured to drive switching of the second optical element by Joule heating in the resistive element;
the series circuit is connected between the row signal line and the column signal line corresponding to the pixel; and
the series circuit is such that a first control signal profile can be applied that is such as to cause switching of the optical state of the first optical element while applying a reverse bias across the diode or TFT with connected drain and gate.

8. The display of claim 7, wherein:
the series circuit is such that a second control signal profile can be applied that is such as to cause switching of the optical state of the second optical element by applying a forward bias across the diode or TFT with connected drain and gate and thereby providing Joule heating in the resistive element.

9. The display of claim 2, wherein:
the pixel comprises a transistor configured to prevent the optical state of the first optical element changing when the second control signal profile is received by the pixel, the second control signal profile being optionally such as to cause the transistor to block a supply of current to drive switching of the first optical element and the first control signal profile being optionally such as to cause the transistor to allow a supply of current to drive switching of the first optical element.

10. (canceled)

11. (canceled)

12. The display of claim 1, further comprising an auxiliary switching system configured to allow the plurality of pixels to be switched as a group between a first operational state and a second operational state,
the first operational state being such that, for each pixel, the first optical element can be switched between at least two optical states by application of a row control signal and a column control signal to the pixel and the second optical element cannot be switched between different optical states by application of a row control signal and a column control signal to the pixel; and
the second operational state being such that, for each pixel, the second optical element can be switched between at least two optical states by application of a row control signal and a column control signal to the pixel and the first optical element cannot be switched between different optical states by application of a row control signal and a column control signal to the pixel.

13. The display of claim 12, wherein the driving controller is configured to:
control switching of the first optical elements of the pixels by applying row control signals and column control signals to the pixels while the pixels are in the first operational state; and
control switching of the second optical elements of the pixels by applying row control signals and column control signals to the pixels while the pixels are in the second operational state.

14. The display of claim 13, wherein the driving controller is configured to switch the pixels alternately between the first operational state and the second operational state using the auxiliary switching system.

15. The display of claim 1, wherein the first optical element is configured to control an overall intensity of the pixel in the overlap region, the first optical element being switchable between a set of optical states comprising at least one optical state having a transmittance of less than 10% and at least one optical state having a transmittance of greater than 90%, wherein the first optical element optionally comprises an LCD element, an electrowetting optical element, or a MEMS element.

16. (canceled)

17. The display of claim 1, wherein the second optical element is configured to control a colour of the pixel in the overlap region, the second optical element being switchable between a set of optical states comprises at least two optical states having different colours.

18. The display of claim 17, wherein the second optical element comprises a phase change material that is thermally switchable between a plurality of stable states having different refractive indices relative to each other.

19. The display of claim 18 wherein the phase change material comprises one or more of the following:
an oxide of vanadium;
an oxide of niobium;
an alloy or compound comprising Ge, Sb, and Te;
an alloy or compound comprising Ge and Te;
an alloy or compound comprising Ge and Sb;
an alloy or compound comprising Ga and Sb;
an alloy or compound comprising Ag, In, Sb, and Te;
an alloy or compound comprising In and Sb;
an alloy or compound comprising In, Sb, and Te;
an alloy or compound comprising In and Se;
an alloy or compound comprising Sb and Te;
an alloy or compound comprising Te, Ge, Sb, and S;
an alloy or compound comprising Ag, Sb, and Se;
an alloy or compound comprising Sb and Se;
an alloy or compound comprising Ge, Sb, Mn, and Sn;
an alloy or compound comprising Ag, Sb, and Te;
an alloy or compound comprising Au, Sb, and Te; and
an alloy or compound comprising Al and Sb.

20. The display of claim 18, wherein each second optical element comprises a stack of layers comprising a spacer layer provided between the phase change material and a reflective layer, wherein the spacer layer consists of a single layer or comprises multiple layers of materials having different refractive indices.

21. The display of claim 18, wherein each second optical element comprises a stack of layers comprising a capping layer, wherein the phase change material is provided between the capping layer and a reflective layer and the capping layer consists of a single layer or comprises multiple layers of materials having different refractive indices.

22. The display of claim 1, wherein the configuring of the driving controller and the pixels such that, for each pixel, the same row signal line and column signal line can be used to switch the first optical element and the second optical element independently of each other comprises configuring each pixel so that the first optical element and the second optical element are respectively responsive to control signals having different frequency characteristics, and configuring the driving controller to be able to selectively provide a control signal to each pixel having frequency characteristics suitable for switching the first optical element and not the second optical element and, at a different time, suitable for switching the second optical element and not the first optical element.

23. The display of claim 1, wherein:
each pixel comprises a first transistor and a second transistor, a gate of the first transistor and a gate of the second transistor are both connected to the row signal line corresponding to the pixel, and the first transistor and the second transistor are configured so that a first row control signal applied simultaneously to the gate of the first transistor and the gate of the second transistor is effective to open the first transistor and thereby allow switching of the first optical element via an electric current passing through the first transistor and to close the second transistor and thereby prevent switching of the second optical element via a current passing through the second transistor, and a second row control signal applied simultaneously to the gate of the first transistor and the gate of the second transistor is effective to open the second transistor and thereby allow switching of the second optical element via an electric current passing through the second transistor and to close the first transistor and thereby prevent switching of the first optical element via an electric current passing through the first transistor; or
each pixel comprises a first transistor and a second transistor, a gate of the first transistor and a gate of the second transistor are both connected to the column signal line corresponding to the pixel, and the first transistor and the second transistor are configured so that a first column control signal applied simultaneously to the gate of the first transistor and the gate of the second transistor is effective to open the first transistor and thereby allow switching of the first optical element via an electric current passing through the first transistor and to close the second transistor and thereby prevent switching of the second optical element via a current passing through the second transistor, and a second column control signal applied simultaneously to the gate of the first transistor and the gate of the second transistor is effective to open the second transistor and thereby allow switching of the second optical element via an electric current passing through the second transistor and to close the first transistor and thereby prevent switching of the first optical element via an electric current passing through the first transistor.
